(19) United States
(12) Patent Application Publication
(10) Pub. No.: US 2009/0034781 A1
(43) Pub. Date: Feb. 5, 2009

(54) Method and Computer Program Product for Providing Object Information

(76) Inventors: Natalia Marmasse, Kibbutz Givat Haim Ichud (IL); Yaakov Navon, Ein Vered (IL); Vova Soroka, Karmiel (IL)

Correspondence Address: IBM CORPORATION, T.J. WATSON RESEARCH CENTER, P.O. BOX 218, YORKTOWN HEIGHTS, NY, 10598, US

(21) Appl. No.: 11/829,953

(22) Filed: Jul. 30, 2007

(51) Int. Cl. G06K 9/00

(52) U.S. Cl. 382/100

(57) ABSTRACT

A method for generating object information, the method includes: acquiring a representation of an object; acquiring contextual information; and processing the representation of the object and the contextual information to provide object information that includes indexing information.

### FIELD OF THE INVENTION

The present invention relates to methods and computer program products for providing object information.

### BACKGROUND OF THE INVENTION

An ordinary person is exposed to ever growing amounts of information of various types. It is hard to recall vast amounts of information, to utilize the acquired information and even share the acquired information.

There is a growing need to provide efficient methods and computer program products that will assist in recalling information, retrieving information and sharing information.

### SUMMARY

A method for generating object information, the method includes: acquiring a representation of an object; acquiring contextual information; and processing the representation of the object and the contextual information to provide object information that includes indexing information.

### BRIEF DESCRIPTION OF THE DRAWINGS

The present invention will be understood and appreciated more fully from the following detailed description taken in conjunction with the drawings in which:

FIG. 1 illustrates a system for generating object information according to an embodiment of the invention;

FIG. 2 illustrates a business card as well as an exemplary address book page, according to an embodiment of the invention;

FIG. 3 is a flow chart of a method for generating object information, according to an embodiment of the invention;

FIG. 4 is a flow chart of a method for generating object information, according to an embodiment of the invention; and

FIG. 5 illustrates a method for providing a service to a customer, according to an embodiment of the invention.

### DETAILED DESCRIPTION OF THE DRAWINGS

Methods and computer program products for generating object information are provided. A representation of an object (such as an object image, an object audio recording, and the like) and contextual information are acquired (captured) and then processed to generate object information. The object information includes indexing information and can be utilized in various processes such as personal information management processes.

The contextual information can include visual information, audio information and text information. The object representation and optionally the contextual information can be acquired by one or more acquisition devices such as mobile devices that in turn may include mobile cameras, mobile phones, cellular phones equipped with cameras (e.g. a camera phones), and the like. Text can be extracted from object representation and/or contextual information captured by a cellular phone equipped with a camera, by a device having speech recognition capabilities and the like. The mobile device can also record audio information.

Conveniently, users can participate in generating object information by acquiring an object representation and associating at least one contextual information with the object representation. The acquisition can be viewed as a tagging process in which the user validates an importance of the object that was imaged.

Object information can be shared between multiple users, can be updated by one or more users, and can be utilized by personal information management processes such as but not limited to calendar, organizer and the like.

Contextual information can include audio that is later processed by voice recognition software and/or remain unchanged. Contextual information can include implicit contextual information, explicit contextual information and derived contextual information.

Implicit contextual information can be generated automatically by the acquisition device (for example—location of the acquisition device, time of acquiring the object representation, configuration of camera while acquiring an object image).

Explicit contextual information can be manually added by the user or prompted for by a contextual information application. Thus, if the user often captures the same contextual information (for example—an image of a business card) he can be prompted to enter such contextual information once he acquires a new object representation. This can be performed by displaying a menu and allowing the user to select the type of the contextual information. Audio information can be regarded as explicit contextual information.

Derived contextual information can also be automatically derived from an object representation (for example by image processing an object image or applying an OCR on an object image), or from other contextual information.

Conveniently, contextual information can relate to future events. For example, a camera phone can be used to collect information on future events from posters, newspapers, and the like. Yet for another example, an occurrence of a future event can also be learnt from audio information that describes the future occurrence of the event.

Contextual information can be used to update a new calendar entry. It is noted that object information can trigger reminders.

Conveniently, object information can be shared between users. The users can belong to large or small communities. A user can edit or otherwise amend object information. If multiple users acquire information about the same object then the acquired information can be combined or otherwise processed. It is noted that acquiring representations of the same object but from different directions, at different illumination (and/or sound) conditions can provide a better visual (or audio) representation of that object and can ease the processing of the object representation and/or contextual information.

It is further noted that contextual information that is acquired in relation to a certain object can become object information of another object. For example, if an image of a poster is acquired in relation to a certain meeting and that poster includes information about another object of interest then the content of the poster can become new object information. The new object information can be linked to the image information that described the meeting but this is not necessarily so.

For simplicity of explanation it is assumed that the images are captured by a mobile communication device that includes a camera. Those of skill in the art will appreciate that an object representation can be captured by another mobile device and sent either to the mobile communication device or to a computer.

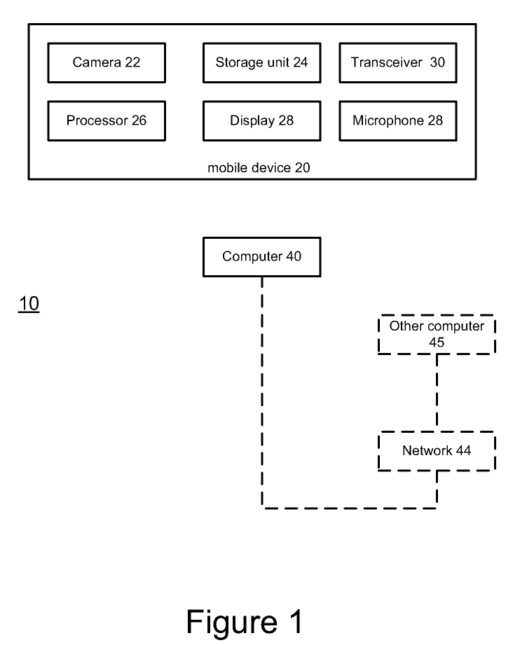

FIG. 1 illustrates system 10 for generating object information according to an embodiment of the invention.

System 10 includes mobile communication device 20 and computer 40. Mobile communication device 20 includes camera 22, storage unit 24, processor 26, display 28, and transceiver 30. Mobile communication device 20 can be regarded as a camera phone. It is noted that mobile communication device 20 can include multiple transceivers. For example, mobile communication device 20 can include long range transceivers (such as CDMA or GSM compliant transceivers) that communicate with cellular networks as well as short range transceivers (including, for example Bluetooth transceivers, infra red transceivers, Wi-Fi transceivers and the like) that communicate with various devices positioned in proximate to the mobile communication device.

According to an embodiment of the invention mobile communication device 20 is capable of processing textual images and extract text from these textual images but this is not necessarily so. The processing can be executed by computer 40. The processing can be partially executed by computer 40 and partially executed by mobile communication device 20. According to another embodiment of the invention text can be extracted from received or recorded audio, by using speech recognition. The audio can be received and/or recorded by the mobile communication device 20 (as illustrated by microphone 32), or by another device.

Conveniently, mobile communication device 20 is able to tag an acquired object representation (such as an object image) with contextual information such as the time of capture. According to an embodiment of the invention mobile communication device 20 or a cellular network can also provide the location of the mobile communication device 20 at the time the object representation was captured. The location can include the cellular network cell that exchanges signals with mobile communication device 20. The location information can include the exact location of mobile communication device 20. Determining a location of a mobile communication device is known in the art are requires no additional description.

Mobile communication device 20 is adapted to capture a representation of an object and to acquire contextual information such as one or more textual images and one or more contextual images. A textual image is an image that includes text. A contextual image provides information about the environment or the context in which the textual image was captured. The same can be applied to textual audio recordings.

A contextual image can include text as well. This text can be processed to provide object information that includes indexing information. Indexing information can include text associated with the object and can enable fast retrieval of object information. The indexing information can be used by personal information management applications including, but not limited to, an address book application, a scheduler application, and the like.

It is also noted that an order of acquiring the object representation and contextual information is usually not relevant. It is further noted that an image of an object can be regarded as contextual information of another object.

Computer 40 can download the object representation and contextual information (such as textual images and contextual images) from mobile communication device 20. It can download images over a wire connection, over a wireless medium or over a network (not shown). Computer 40 can be connected over network 44 to an intermediate component (such as another computer 45). The intermediate component can receive images from mobile communication device 20 and send these images to computer 40. It is further noted that mobile communication device 20 and computer 40 can be linked via cellular network 46.

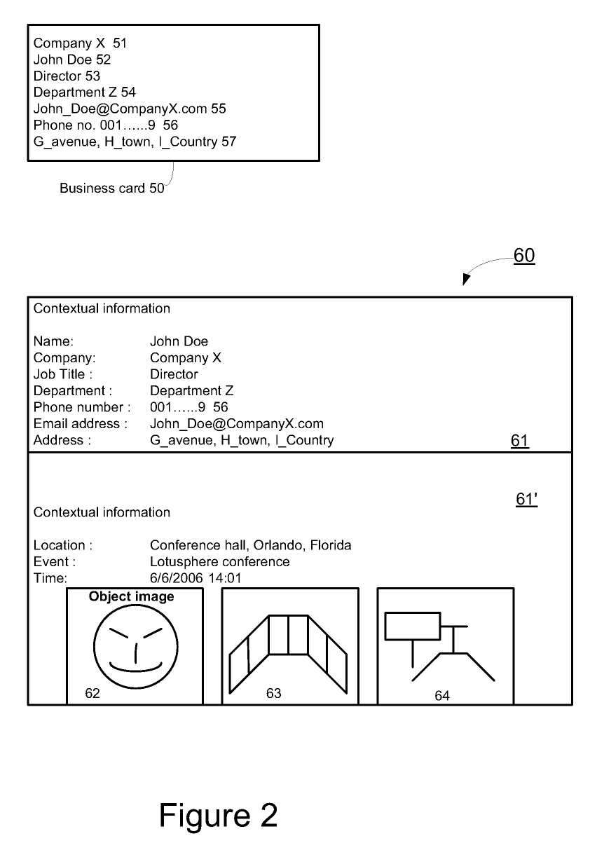

FIG. 2 illustrates an exemplary business card 50 as well as an exemplary address book page 60, according to an embodiment of the invention.

Business card 50 includes the following contextual information: a name of a company “company X” 51, a name of an employee “John Doe” 52, the title of the employee “Director” 53, the department of the employee “Department Z” 54, the email address of the employee “John_Doe@CompanyX.com” 55, the phone number of the employee “001 . . . 9” 56, and the address of the employee “G_avenue, H_town, I_Country” 57. It is noted that a business card can include fewer details, alternative details, as well as more details. Conveniently, this business cards is associated with an image of John Doe.

It is assumed that a mobile communication device captured an image of John Doe 62 as well as contextual information such as an image of business card 50, as well as two contextual images 63 and 64. Contextual images 63 and 64 are images of the conference hall in which the images were captured.

Address book page 60 can include the textual details of John Doe, especially those that are included in business card 50. The upper portion (denoted 61) of page 60 includes these textual details.

The central portion 61′ of page 60 includes contextual information such as the location of the conference hall (can be extracted from the location of the mobile communication device that captured the images), the name of the event (can be extracted from contextual image), the time in which the contextual images were captured and the contextual images themselves.

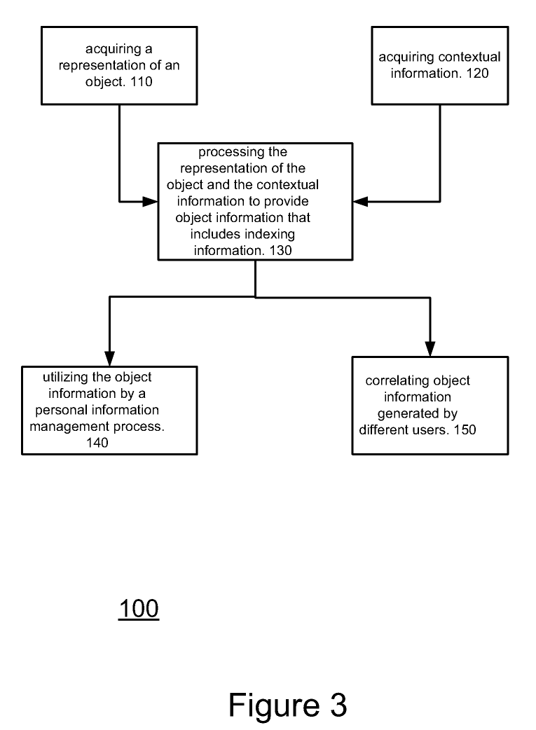

FIG. 3 is a flow chart of method 100 for generating object information, according to an embodiment of the invention.

Method 100 starts by stages 110 and 120. Stage 110 includes acquiring a representation of an object. Stage 110 can be executed by a mobile phone that includes a camera (if an object image is acquired) or by a mobile device capable of acquiring an audio representation of an object.

Stage 120 includes acquiring contextual information. Stage 110 can precede stage 120, can follow stage 120 can be executed in parallel to stage 120 and the like.

According to various embodiments of the invention stage 120 can include at least one of the following operations: (i) implicitly acquiring contextual information, (ii) acquiring audio information, (iii) explicitly acquiring contextual information, (iv) acquiring derived contextual information, or (v) acquiring a textual image.

Stages 110 and 120 are followed by stage 130 of processing the representation of the object and the contextual information to provide object information that includes indexing information.

The object information can describe the object, can indicate when the object was pictured, can illustrate the context of the meeting with the object (or seeing the object), and the like. Object information can relate to an event during which the object was pictured and can also relate to future events that were described in the object of the image or in contextual information acquired in relation to the object. Object information can include audio information as well as text information representative of the audio information.

Stage 130 is followed by stage 140 of utilizing the object information by a personal information management process. For example, object information can trigger reminders, including reminders to call the object, reminders to participate in a future event, and the like. Yet for other examples, stage 140 can include updating a calendar (by adding an event that was announced and captured by a textual image), by adding a new entry to an address book, by updating a bookmark, adding things to a “to do” list, updating a diary and the like.

Stage 130 can also be followed by stage 150 of correlating object information generated by different users. The correlation can include comparing representations of the object, constructing a multi-dimensional representation of the object, comparing textual information about the object, audio information relating to the object, and the like.

Stage 120 can include receiving an indication from a user that a captured image is a textual image.

Conveniently, method 100 can include acquiring a set of images, processing the images and deciding which will be an image of an object and with images are contextual images. The decision can also include determining that a contextual image is a textual image from which text can be extracted. That textual image can be an image of a business card, of a paper clip, of an announcement printed on a placard and the like.

Referring to FIG. 1, stage 130 can be executed by mobile device 20, by computer 40, partially by mobile device and partially by computer 40.

Conveniently, stage 130 includes invoking a user to decode text from a textual image if a text decoding failure occurred. Thus, the user can be instructed to enter text that was not properly decoded (for example text that was out of focus, text that includes unrecognized symbols and the like), and this text will be added to the text that was successfully extracted from the textual image.

Stage 130 also includes linking between the image of the object and one or more contextual images. Conveniently, the linking is responsive to the capture time of the textual image and time of capturing of the at least one contextual image, to a location of the mobile communication device during the capture of the textual image and to a location of the mobile communication device during the capture of the at least one contextual image.

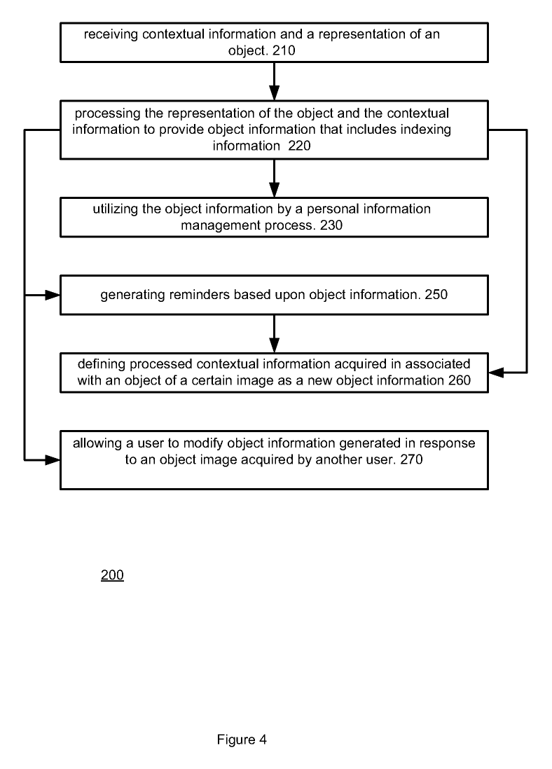

FIG. 4 is a flow chart of method 200 for processing images, according to an embodiment of the invention.

Method 200 starts by stage 210 of receiving contextual information and a representation of an object. Stage 210 can include receiving a representation of an object that was acquired by a mobile communication device that includes a camera, a sound recorder and the like. Referring to the example set fourth in FIG. 1 computer 40 or another computer 45 can receive a representation of an object, information representative of the image of the object, audio representative to the object, contextual information that includes textual images, contextual images, audio, text, text representative of an acquired audio and the like. The reception can made over wired channels, wireless channels or a combination thereof.

Stage 210 is followed by stage 220 of processing the representation of the object and the contextual information to provide object information that includes indexing information. The processing can include image processing, image recognition, audio processing, speech processing, associating between information of various types, and the like. The indexing information can be used for retrieval of object information by various processes and/or applications such as personal information management processes.

Stage 220 conveniently includes processing a contextual image to extract the indexing information.

Stage 220 is followed by stage 230 of utilizing the object information by a personal information management process. This can include scheduling a meeting, sending a reminder, adding object information to an address book, and the like. Stage 230 conveniently includes invoking a user to decode text from the textual image if a text decoding failure occurred.

Method 200 conveniently includes at least one of the following stages: stage 250 of generating reminders based upon object information, stage 260 of defining processed contextual information acquired in associated with an object of a certain image as a new object information and stage 270 of allowing a user to modify object information generated in response to an object representation acquired by another user.

Conveniently, stage 220 includes invoking a user to decode text from the textual image if a text decoding failure occurred. Thus, if one or more alphanumeric symbol were not decoded the user may be requested to enter these symbols.

Conveniently, stage 210 includes receiving an image that includes a uniform resource location address (URL) and stage 220 includes adding the URL to a database.

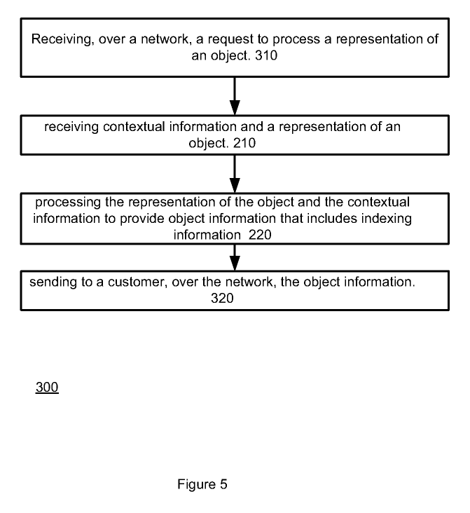

FIG. 5 illustrates a method 300 for providing a service to a customer, according to an embodiment of the invention.

Method 300 starts by stage 310 of receiving, over a network, a request to process a representation of an object.

Stage 310 is followed by stage 210 of receiving contextual information and the representation of an object. The contextual information can also be provide over the network, but this is not necessarily so. Stage 210 can include receiving an image of an object that was acquired by a mobile communication device that includes a camera. Referring to the example set fourth in FIG. 1 computer 40 or another computer 45 can receive the request, information representative of the object, contextual information that includes textual images, contextual images, audio, text, text representative of an acquired audio and the like. The reception can made over wired channels, wireless channels or a combination thereof.

Stage 210 is followed by stage 220 of processing the representation of the object and the contextual information to provide object information that comprises indexing information. The processing can include image processing, image recognition, audio processing, speech processing, associating between information of various types, and the like. The indexing information can be used for retrieval of object information by various processes and/or applications such as personal information management processes.

Stage 220 conveniently includes processing a contextual image to extract the indexing information.

Stage 220 is followed by stage 320 of sending to a customer, over the network, the object information.

According to other embodiments of the invention the request of stage 310 can include a request to receive a product of an appliance of a personal information management process on the image information. Accordingly, such request will be responded by executing stage 230 of utilizing the object information by a personal information management process. In this case stage 250 will include sending to the customer a product of appliance of the at least one personal information management process. This can be an entry of an address book, a calendar, a “to do” list, a diary, a bookmark and the like.

It is further noted that additional stage of method 200 can be included in method 300. The information sent to the customer over the network can vary accordingly.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

We claim:

1. A method for generating object information, the method comprises: acquiring a representation of an object; acquiring contextual information; and processing the representation of the object and the contextual information to provide object information that comprises indexing information.

2. The method according to claim 1 further comprising utilizing the object information by a personal information management process.

3. The method according to claim 1 wherein the stage of acquiring contextual information comprises implicitly acquiring contextual information.

4. The method according to claim 1 wherein the stage of acquiring contextual information comprises acquiring audio information.

5. The method according to claim 1 wherein the stage of acquiring contextual information comprises acquiring derived contextual information.

6. The method according to claim 1 further comprising correlating object information generated by different users.

7. The method according to claim 1 wherein the method comprises acquiring the representation of the object and the contextual information by the mobile phone that comprises a camera.

8. The method according to claim 1 wherein the stage of acquiring contextual information comprises acquiring a textual image, and wherein the stage of processing comprises processing the textual image to extract text and linking between the image of the object and extracted text.

9. The method according to claim 1 further comprising retrieving object information by utilizing indexing information associated with the object information.

10. A method for processing images, the method comprises: receiving contextual information and a representation of an object; and processing the representation of the object and the contextual information to provide object information that comprises indexing information.

11. The method according to claim 10 further comprising utilizing the object information by a personal information management process.

12. The method according to claim 10 wherein the receiving comprises receiving an image of an object that was acquired by a mobile communication device that comprises a camera.

13. The method according to claim 10 wherein the processing is followed by invoking a user to decode text from the textual image if a text decoding failure occurred.

14. The method according to claim 10 further comprising processing a contextual image to extract the indexing information.

15. The method according to claim 10 further comprising generating reminders based upon object information.

16. The method according to claim 10 further comprising defining processed contextual information acquired in association with an object of a certain image as a new object information.

17. The method according to claim 10 further comprising allowing a user to modify object information generated in response to an object representation acquired by another user.

18. A computer program product comprising a computer usable medium including a computer readable program, wherein the computer readable program when executed on a computer causes the computer to: receive contextual information and a representation of an object; and process the representation of the object and the contextual information to provide object information that comprises indexing information.

19. The computer program product according to claim 18 that causes the computer to utilize the object information by a personal information management process.

20. The computer program product according to claim 18 that causes the computer to process a contextual image to extract the indexing information.
